(19) United States
(12) Patent Application Publication
(10) Pub. No.: US 2019/0003514 A1
(43) Pub. Date: Jan. 3, 2019

(54) DUAL LAMINATE GALVANIC ISOLATION

(71) Applicants: James Roger Lackore, JR., Big Bend, WI (US); Scott D. Williamson, Dodge, NE (US)

(72) Inventors: James Roger Lackore, JR., Big Bend, WI (US); Scott D. Williamson, Dodge, NE (US)

(73) Assignee: Spartan Motors, Inc., Charlotte, MI (US)

(21) Appl. No.: 15/639,472

(22) Filed: Jun. 30, 2017

(51) Int. Cl. F16B 33/00; F16B 5/02

(52) U.S. Cl. CPC F16B 33/004; F16B 5/02

(57) ABSTRACT

Embodiments of a method of galvanically isolating a first metal piece from a second metal piece are provided. In particular, the first metal piece and the second metal piece are different metals or alloys, and the first metal piece and the second metal piece are secured together with a fastener. The method includes the step of bonding a first metal strip to the second metal piece such that the first metal strip prevents direct physical contact between the first metal piece and the second metal piece. The method also includes the step of bonding a second metal strip to the second metal piece such that the second metal strip prevents direct physical contact between the fastener and the second metal in an axial direction. Embodiments of a laminate structure are also provided.

### FIELD OF THE INVENTION

This invention generally relates to a system and method of reducing instances of galvanic corrosion, and more particularly, embodiments of this invention relate to laminated layers of metal and a method of laminating layers of metal to substantially prevent galvanic corrosion.

### BACKGROUND OF THE INVENTION

In many applications, dissimilar metals are used and brought into contact with each other in a single product. Dissimilar metals frequently also have dissimilar anodic indices. When such dissimilar metals are exposed to an electrolyte, such as salty water, and when an electrical path exists between the metals, the difference in anodic indices will cause the more anodic metal to corrode faster than it might otherwise corrode when exposed to the same environmental conditions.

For example, vehicles using dissimilar metals that are placed in contact with each other are susceptible to galvanic corrosion. In particular, the vehicle substructure and body may be made of dissimilar metals, such as stainless steel and aluminum, respectively. Previous attempts have been made to prevent such galvanic corrosion by using, e.g., non-conducting isolation tape or compressible nylon insulating materials. However, this method only reduces the potential for electrons to pass between the two metals where they contact, but electron flow can still occur at the bolted joints through the fasteners. Further, the use of compressible materials between the metal components can lead to a loss of clamp load over time.

Embodiments of the presently disclosed invention address the problems associated with using dissimilar metals that are used in a single product, including the problems of galvanic corrosion and loss of clamp load. These and other advantages of the invention, as well as additional inventive features, will be apparent from the description of the invention provided herein.

### BRIEF SUMMARY OF THE INVENTION

In one aspect, embodiments of a method of galvanically isolating a first metal piece from a second metal piece are provided. In particular, the first metal piece and the second metal piece are different metals or alloys, and the first metal piece and the second metal piece are secured together with a fastener. The method includes the step of bonding a first metal strip to the second metal piece such that the first metal strip prevents direct physical contact between the first metal piece and the second metal piece. The method also includes the step of bonding a second metal strip to the second metal piece such that the second metal strip prevents direct physical contact in an axial direction between the fastener.

In particular embodiments of the method, the first metal piece is a body of a vehicle and the second metal piece is a substructure of the vehicle. In such an embodiment, the method also includes the steps of selecting the body of the vehicle to be made substantially of an aluminum alloy and selecting the substructure of the vehicle to be made substantially of a stainless steel alloy. In a specific embodiment, a step of selecting the fastener to be a galvanized steel fastener is included in the method.

In another particular embodiment, the method further includes the step of surrounding the fastener with an insulating sleeve so as to prevent direct physical contact in a radial direction between the fastener and the first metal piece and between the fastener and the second metal piece. In embodiments, the insulating sleeve is selected to be plastic.

In still other embodiments, the first metal strip and the second metal strip are selected to be the same metal or alloy as the first metal piece. However, in other embodiments, the first metal strip and the second metal strip are selected to include the same major elemental component as the first metal. Yet, in other embodiments, the first metal strip and the second metal strip are selected to be a metal or alloy having an anodic index that is within +/−0.15V of the alloy or metal of the first metal piece.

In another aspect, embodiments of a laminate structure are provided. The laminate structure is held together by at least one fastener. The laminate structure includes a first metal piece and a second metal piece in which the first metal piece and the second metal piece are different metals or alloys. The laminate structure also includes a first metal strip disposed between the first metal piece and the second metal piece and a second metal strip configured to prevent direct physical contact in an axial direction between the fastener and the second metal piece. The first metal strip and the second metal strip are bonded to opposite surfaces of the second metal piece. Further, the first metal piece is not in physical contact with the second metal piece at any point throughout the laminate structure.

In an embodiment, the first metal piece is a body of a vehicle, and the second metal piece is a substructure of the vehicle. Further, in embodiments, the body of the vehicle is made substantially of an aluminum alloy and wherein the substructure of the vehicle is made substantially of a stainless steel alloy. Further, in a particular embodiment, the fastener is a galvanized steel fastener.

In some embodiments, the laminate structure further includes an insulating sleeve that is placed around the fastener so as to prevent direct physical contact in a radial direction between the fastener and the first metal piece and between the fastener and the second metal piece. In particular, embodiments of the laminate structure include an insulating sleeve made from plastic.

In some embodiments of the laminate structure, the first metal strip and the second metal strip are the same metal or alloy as the first metal piece. In other embodiments of the laminate structure, the first metal strip and the second metal strip include the same major elemental component as the first metal. In still other embodiments of the laminate structure, the first metal strip and the second metal strip are a metal or alloy having an anodic index that is within +/−0.15V of the alloy or metal of the first metal piece.

In still other embodiments of the laminate structure, each of the first metal piece, the first metal strip, and the second metal strip has an aperture of a first size adapted to receive the at least one fastener. Further, the second metal piece has an aperture of a second size that is larger than the first size such that a shank of the fastener does not contact the second metal piece when the fastener is inserted through the apertures. In such an embodiment, the aperture of the second size has a diameter that is greater than 125% of a diameter of the shank of the fastener.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 depicts an isometric view of a laminated structure secured together by bolts, according to an exemplary embodiment;

FIG. 2 is a cross-sectional view of the laminated structure of FIG. 1;

FIG. 3 depicts an exploded view of another embodiment of a laminated structure secured together by a bolt, according to an exemplary embodiment; and

FIG. 4 is a cross-sectional view of the embodiment of FIG. 3 in the assembled form, according to an exemplary embodiment.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Embodiments of a laminate structure that prevent or substantially reduce the instance of galvanic corrosion between two dissimilar metal pieces are disclosed herein. The laminate structure uses two strips of metal bonded to opposing surfaces of one of the metal pieces at the location wherein the dissimilar metal pieces are fastened together. In this manner, the total area of electrical flow path, including through the fastener, between the dissimilar metals is greatly reduced. Accordingly, galvanic corrosion is thereby prevented or substantially reduced.

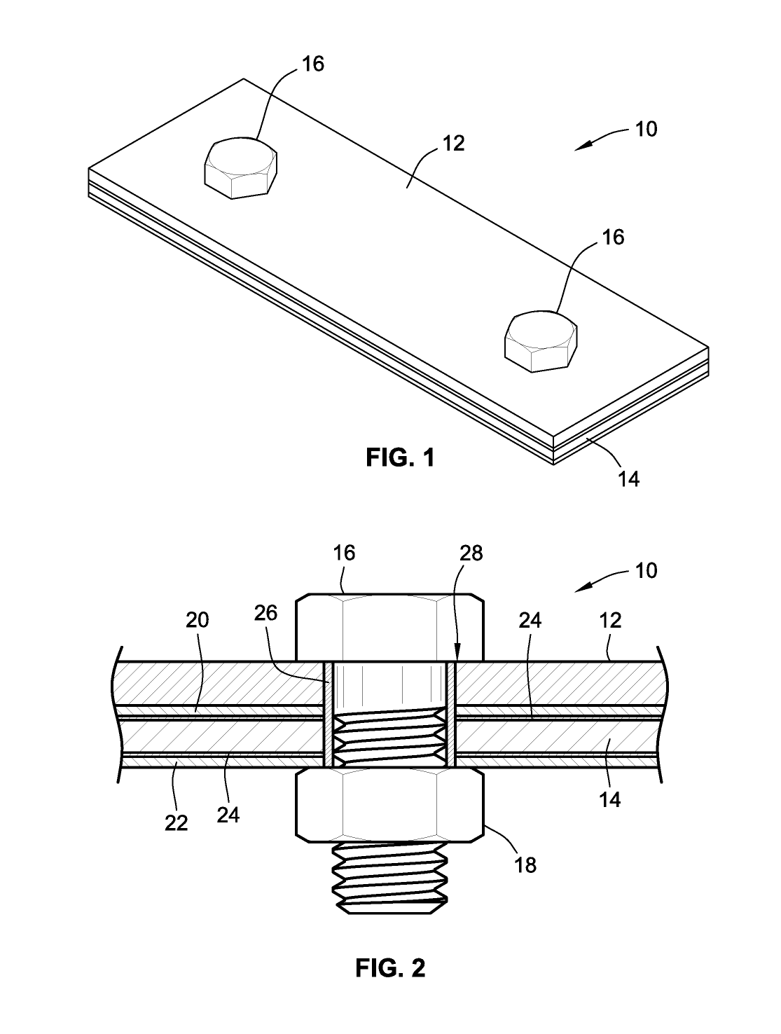

A laminate structure 10 is depicted in FIG. 1. The laminate structure 10 includes a first metal piece 12 and a second metal piece 14. The first metal piece 12 and second metal piece 14 are two different metals or alloys. The laminate structure 10 is representative of any of a variety of applications in which dissimilar metals are fastened together. In an exemplary embodiment, the first metal piece 12 is a body of a vehicle, and the second metal piece 14 is a superstructure of a vehicle. In a further exemplary embodiment, the first metal piece 12 is an aluminum alloy, and the second metal piece 14 is a stainless steel alloy. The first metal piece 12 and the second metal piece 14 are fastened together via fasteners 16.

As illustrated in FIG. 1, the fasteners 16 are bolts, which each have a corresponding nut 18 depicted in FIG. 2. However, in other embodiments, the fasteners are clevis/cotter pins, rivet, round prong fastener, bent shank fastener, etc. Generally, the fastener 16 has two surfaces that apply a clamp load to the laminae structure 10. In the case of the bolt depicted in FIG. 2, the head of the fastener 16 and the nut 18 apply the clamp load on the laminate structure 10. More generally, the fastener 16 has two axial surfaces (axial, in this case, refers to the longitudinal axis along the fastener 16 shank) that apply a clamp load to the laminate structure 10.

As mentioned above, different types of metals and alloys often have different anodic indices, which can cause galvanic corrosion when in the presence of an electrolyte. In the exemplary embodiment of an aluminum vehicle body and a stainless steel superstructure, water from rain or snow mixed with dissolved materials from the road (e.g., road salt) can act as an electrolyte to facilitate galvanic corrosion. Referring to FIG. 2, galvanic corrosion is prevented or substantially reduced in the laminate structure 10 by laminating a first metal strip 20 and a second metal strip 22 to either of the first metal piece 12 or the second metal piece 14.

In the particular embodiment depicted, the first metal strip 20 and the second metal strip 22 are laminated to the second metal piece 14. The first metal strip 20 and the second metal strip 22 are made of the same or similar metal or alloy as the metal piece to which they are not bonded. Thus, for the embodiment depicted, the first metal strip 20 and the second metal strip 22 are made of the same or similar metal or alloy as the first metal piece 12. By “similar metal or alloy,” it is meant that the first metal strip 20 and second metal strip 22 do not have to be the exact same metal or alloy as the first metal piece 12, but the first metal strip 20 and second metal strip 22 are selected to have the same major elemental component as the first metal piece 12. For example, if the first metal piece 12 is a particular aluminum alloy, such as an AA6xxx alloy, then in embodiments the first metal strip 20 and the second metal strip 22 are aluminum or another aluminum alloy (from the AA6xxx series or another series). In another embodiment, the first metal strip 20 and the second metal strip 22 are a metal or alloy that is dissimilar from the first metal piece 12 but that has an anodic index that is within +/−0.15 V of the metal or alloy of the first metal piece 12. Thus, a “similar metal or alloy” also includes metals and alloys that do not have the same major elemental component if the metal or alloy has an anodic index within a specified range of the metal piece.

As shown in FIG. 2, the first metal strip 20 and the second metal strip 22 are bonded to opposite surfaces (e.g., the top and bottom surfaces) of the second metal piece 14 using adhesives 24. The adhesives 24 provide a layer of electrical insulation between the first metal strip 20 and the second metal piece 14 and between the second metal strip 22 and the second metal piece 14. In this way, the first metal strip 20 prevents direct physical contact between the first metal piece 12 and the second metal piece 14, and the second metal strip 22 prevents direct physical contact between the second metal piece 14 and the nut 18 (although, in a different fastening or physical orientation, the second metal strip 22 could instead prevent direct physical contact between the head of the fastener 16 and the second metal piece 12). Thus, the second metal strip 22 prevents direct physical contact with the fastener in the axial direction (i.e., with the axial surfaces of the fastener 16 along the longitudinal axis of the fastener 16).

In a further embodiment, an insulating sleeve 26 is placed around the fastener 16 so as to further reduce any electrical flow paths between the shank or threads of the fastener 16 and a through hole 28 through the laminate structure 10. Thus, the insulating sleeve 26 prevents direct physical contact between the first metal piece 12 and the fastener 16 and between the second metal piece 14 and the fastener 16 in the radial direction (i.e., in the direction transverse to the longitudinal axis of the fastener 16). In embodiments, the insulating sleeve 26 is selected to be a plastic insulating sleeve. Advantageously, the use of the insulating sleeve 26 does not affect clamp load because it is not located between any of the surfaces subject to clamping loads (as compared to a layer of compressible material, which, as discussed above, would be placed between surfaces subject to clamping loads).

While galvanic corrosion between the first metal piece 12 and the second metal piece 14 has primarily been discussed herein, galvanic corrosion between the first metal piece 12 and fastener 16 is also preferably reduced or eliminated. As shown in FIG. 2, the first metal piece 12 is in contact with the head of the fastener 16 and the second metal strip 22 is in contact with the nut 18. The first metal piece 12 and the fastener 16 may be different metals or alloys, and the second metal strip 22 and the nut 18 may be different metals or alloys. As discussed above, the first metal piece 12 and the second metal strip 22 are selected to be the same or similar metal or alloy. Thus, in embodiments, the fastener 16 and nut 18 are also selected to be the same or similar metal alloy as the first metal piece 12 and the second metal strip 22. Also as discussed above, the same or similar metal or alloy includes metals or alloys having an anodic index within +/−0.15 V. In one exemplary embodiment in which the first metal piece 12 and the second metal strip 22 are aluminum or an aluminum alloy, the fastener 16 and nut 18 are selected to be hot-dipped galvanized steel.

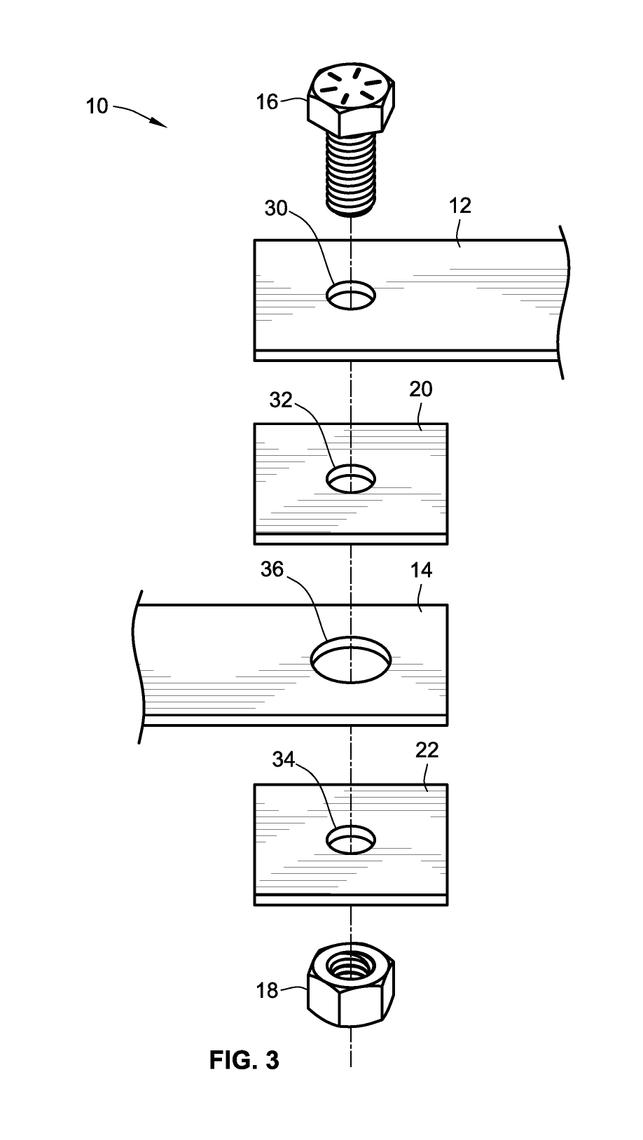

Another embodiment of a laminate structure 10 is depicted in FIG. 3. In particular, the first metal piece 12, the second metal piece 14, fastener 16, nut 18, the first metal strip 20, and the second metal strip 22 of the laminate structure 10 are shown in exploded form. As can be seen, the first metal piece 12, the first metal strip 20, and the second metal strip 22 include a first aperture 30, a second aperture 32, and a third aperture 34, respectively. These apertures 30, 32, 34 have the same diameter, which is smaller than a fourth aperture 36 in the second metal piece 14. Further, the first aperture 30, the second aperture 32, and the third aperture 34 have diameters that are slightly larger than the thread diameter of the fastener 16 (if the fastener 16 is a threaded fastener; otherwise the apertures 30, 32, 34 have diameters that are slightly larger than the fastener shank). In embodiments, the first aperture 30, the second aperture 32, and the third aperture 34 have diameters that are >100% and ≤125% of the thread diameter of the fastener 16. In a preferred embodiment, the first aperture 30, the second aperture 32, and the third aperture 34 have diameters that are from 105% to 115% of the thread diameter of the fastener 16.

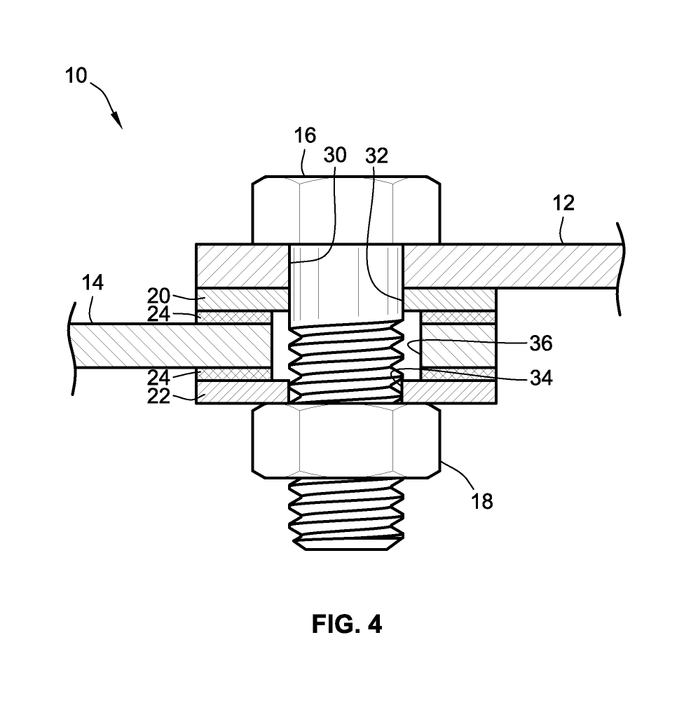

As mentioned, the fourth aperture 36 has a larger diameter than the apertures 30, 32, 34. In an embodiment, the fourth aperture 36 is greater than 125% of the thread diameter of the fastener 16. In a more preferred embodiment, the fourth aperture is from 150% to 200% of the thread diameter of the fastener 16. Because of the larger diameter of the fourth aperture 36, the laminate structure 10 is able to be assembled without the shank of the fastener 16 touching the second metal piece 14. A cross-sectional view of the assembled laminate structure 10 is shown in FIG. 4.

As depicted in FIG. 4, the first metal strip 20 and the second metal strip 22 are laminated to the second metal piece 14 via adhesive 24. In preparing the laminate structure 10, preferably the apertures 32, 34 of the first metal strip 20 and the second metal strip 22 are aligned over the center of the fourth aperture 36 in the second metal piece 14. The first metal piece 12 is then joined to the laminate structure 10 by inserting the fastener 16, e.g., a bolt, through the apertures 30, 32, 34, 36. The fastener 16 is then secured via nut 18. Because the shank of the fastener 16 does not contact the second metal piece 14, no electrical flow between the first metal piece 12 and the second metal piece 14 through the shank of the fastener 16 is possible, which limits (if not eliminates) the possibility of galvanic corrosion. Notwithstanding, the clamp load of the fastener 16 and nut 18 are not affected because the load is applied to metal layers instead of to materials like rubber and nylon that lose their compressibility over time.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of galvanically isolating a first metal piece from a second metal piece in which the first metal piece and the second metal piece are different metals or alloys and in which the first metal piece and the second metal piece are secured together with a fastener, the method comprising the steps of:
bonding a first metal strip to the second metal piece such that the first metal strip prevents direct physical contact between the first metal piece and the second metal piece; and
bonding a second metal strip to the second metal piece such that the second metal strip prevents direct physical contact in an axial direction between the fastener and the second metal piece.

2. The method of claim 1, further comprising the step of selecting the first metal piece to be a body of a vehicle and selecting the second metal piece to be a substructure of the vehicle.

3. The method of claim 2, further comprising the steps of:
selecting the body of the vehicle to be made substantially of an aluminum alloy; and
selecting the substructure of the vehicle to be made substantially of a stainless steel alloy.

4. The method of claim 3, further comprising the step of selecting the fastener to be a galvanized steel fastener.

5. The method of claim 1, further comprising the step of surrounding the fastener with an insulating sleeve so as to prevent direct physical contact in a radial direction between the fastener and the first metal piece and between the fastener and the second metal piece.

6. The method of claim 5, wherein the step of surrounding the fastener with an insulating sleeve further comprises selecting the insulating sleeve to be plastic.

7. The method of claim 1, further comprising the step of selecting the first metal strip and the second metal strip to be the same metal or alloy as the first metal piece.

8. The method of claim 1, further comprising the step of selecting the first metal strip and the second metal strip to include the same major elemental component as the first metal piece.

9. The method of claim 1, further comprising the step of selecting the first metal strip and the second metal strip to be a metal or alloy having an anodic index that is within +/−0.15V of the alloy or metal of the first metal piece.

10. A laminate structure in which the laminate structure is held together by at least one fastener, comprising:
a first metal piece;
a second metal piece, wherein the first metal piece and the second metal piece are comprised of different metals or alloys;
a first metal strip disposed between the first metal piece and the second metal piece; and
a second metal strip configured to prevent direct physical contact between the fastener the second metal piece in an axial direction;
wherein the first metal strip and the second metal strip are bonded to opposite surfaces of the second metal piece; and
wherein the first metal piece is not in physical contact with the second metal piece throughout the laminate structure.

11. The laminate structure of claim 10, wherein the first metal piece is a body of a vehicle and the second metal piece is a substructure of the vehicle.

12. The laminate structure of claim 11, wherein the body of the vehicle is made substantially of an aluminum alloy and wherein the substructure of the vehicle is made substantially of a stainless steel alloy.

13. The laminate structure of claim 12, wherein the fastener is a galvanized steel fastener.

14. The laminate structure of claim 10, further comprising an insulating sleeve that is placed around the fastener, wherein the insulating sleeve prevents direct physical contact in a radial direction between the fastener and the first metal piece and between the fastener and the second metal piece.

15. The laminate structure of claim 14, wherein the insulating sleeve is made from plastic.

16. The laminate structure of claim 10, wherein the first metal strip and the second metal strip are the same metal or alloy as the first metal piece.

17. The laminate structure of claim 10, wherein the first metal strip and the second metal strip include the same major elemental component as the first metal.

18. The laminate structure of claim 10, wherein the first metal strip and the second metal strip are a metal or alloy having an anodic index that is within +/−0.15V of the alloy or metal of the first metal piece.

19. The laminate structure of claim 10, wherein each of the first metal piece, the first metal strip, and the second metal strip has an aperture of a first size adapted to receive the at least one fastener and wherein the second metal piece has an aperture of a second size that is larger than the first size such that a shank of the fastener does not contact the second metal piece when the fastener is inserted through the apertures.

20. The laminate structure of claim 10, wherein the aperture of the second size has a diameter that is greater than 125% of a diameter of the shank of the fastener.
